(19) United States
(12) Patent Application Publication
(10) Pub. No.: US 2004/0105129 A1
(43) Pub. Date: Jun. 3, 2004

(54) Image processing apparatus

(76) Inventor: Yasuhiro Kawakami, Munakata-shi (JP)

Correspondence Address: STEVENS, DAVIS, MILLER & MOSHER, L.L.P., Suite 850, 1615 L Street, Washington, DC, 20036, US

(21) Appl. No.: 10/717,475

(22) Filed: Nov. 21, 2003

(30) Foreign Application Priority Data
Nov. 28, 2002 (JP) P. 2002-345483

(51) Int. Cl. G06K 15/02; H04N 1/393; H04N 1/40; H04N 1/409

(52) U.S. Cl. 358/2.1; 358/1.2; 358/3.27

(57) ABSTRACT

An image processing apparatus performing image processing when a printing resolution of an image output apparatus is higher than a reading resolution of an image input apparatus, so that image data read by the image input apparatus is converted to image data having a high resolution to be outputted from the image output apparatus. When an original contains both a text and a picture, the apparatus performs image-region segmentation processing to identify the text and the picture, and increasing a resolution of a text region to be higher than a resolution of a picture region within an output image of the original, while making the number of pixels equal in the entire output image after binarization of each region.

### BACKGROUND OF THE INVENTION

1. Field of the Invention

The present invention relates to an image processing apparatus that reads image data and produces a printed output thereof.

2. Description of Background Art

A conventional image processing apparatus performs image processing on image data read by an image input apparatus, such as a scanner, at a resolution fit for either a text or a picture even when the original contains both the text and the picture (for example, JP-A-2000-13611).

The foregoing will be described in detail in the following.

FIG. 6 is a schematic view showing image data inputted into a conventional image processing apparatus. FIG. 7 is a schematic view showing resolution conversion processing when the image data inputted into the conventional image processing apparatus is data of a text region (text image data). FIG. 8 is a schematic view showing resolution conversion processing when the image data inputted into the conventional image processing apparatus is data of a picture region (picture image data). FIG. 9 is a schematic view showing a size of isolated dots when the image data inputted into the conventional image processing apparatus is data containing both a text region and a picture region and the data of the picture region is subjected to resolution conversion processing to match with a resolution of 300 dpi. FIG. 10 is a schematic view showing a size of isolated dots when the image data inputted into the conventional image processing apparatus is data containing both a text region and a picture region and the data of the picture region is subjected to resolution conversion processing to match with a resolution of 600 dpi.

For example, assume that a reading resolution of the image input apparatus is 200 dpi as shown in FIG. 6 and a printing resolution of an image output apparatus is 600 dpi. Then, in the case of an original containing a text region (text image) alone, the data is read at 200 dpi, subjected to various corrections, such as the shading correction, the gamma correction, and the edge enhancement correction (MTF correction), and printed after it is converted to match with a high resolution of 600 dpi. Consequently, as shown in FIG. 7, a satisfactory printing result at a high resolution of 600 dpi can be obtained. Also, in the case of an original containing a picture region (picture image) alone, the data is read at 200 dpi, subjected to various corrections, and printed after it is converted to match with a medium resolution of 300 dpi. Consequently, as shown in FIG. 8, a satisfactory printing result at a medium resolution of 300 dpi can be obtained.

However, in the case of an original containing both a text region (text image) and a picture region (picture image), the conventional image processing apparatus configured as described above adopts either of the following methods: a method of converting the picture region (picture image) to have a resolution of 600 dpi to match with a satisfactory resolution of the text region, 600 dpi; or conversely, a method of converting the text region (text image) to have a resolution of 300 dpi to match with a satisfactory resolution of the picture region, 300 dpi. The reason why is as follows. That is, when the data is printed by performing resolution conversion on a picture region (picture image) to have a resolution of 600 dpi to match wit the resolution of a text region (text image), a satisfactory printing result can be obtained reliably for the text region (text image). A picture region (picture image) at a high resolution of 600 dpi, however, has a problem in reproducibility of isolated dots, and the picture region (picture image) has a far lower resolution, which results in deterioration of a print quality.

A relation between the resolution of a picture region (picture image) and a print quality will now be described. Originally, a text is represented by a set of linked dots, that is, a set of continuous dots. Hence, as the resolution is increased, a contour of text image represented by a set of continuous dots becomes smoother, and a printing result of a higher quality can be obtained. However, because half-tone dot meshing processing is applied to a portion of the picture region (picture image), the picture region is represented by a set of originally discrete dots, that is, a set of isolated dots. Hence, in the case of a medium resolution of 300 dpi as shown in FIG. 9, each isolated dot is of an adequate size, and an isolated dot of this size is able to maintain an adequate adhesion force to print paper. However, in the case of a high resolution of 600 dpi as shown in FIG. 10, the isolated dots becomes too small, and an adhesion force to print paper of each isolated dot becomes so poor that isolated dots indicated by hatching with broken lines fall off from the print paper. As a result, in a case shown in FIG. 10, a fixing ratio of the entire toner to print paper in the picture region (picture image) is lower than in a case in FIG. 9 (in other words, an image fades as the isolated dots fall off), and an overall print quality of an output image of the original is deteriorated. That is to say, theoretically, the picture region (picture image) has a resolution as high as that of the text region (text image); however, isolated dots smaller than required are generated and a fixing ratio of the toner in the portion of the picture region is lowered, which deteriorates a print quality of the portion of the picture region.

Conversely, in a case where the data is printed by converting the text region (text image) to have a resolution of 300 dpi to match with the resolution of the picture region (picture image), a fixing ratio of the toner in the portion of the picture region is increased because too small isolated dots are-eliminated, and a satisfactory printing result can be obtained for the portion of the picture region (picture image) However, because the text region (text image) is printed at a medium resolution of 300 dpi, a print quality of a portion of the text region (text image) is naturally deteriorated.

Conventionally, for an original containing both a text and a picture as described above, the resolution of either a text or a picture has to be matched with the resolution of the other, which has a problem that an overall print quality cannot be fully satisfied regardless of whether which of the text or the picture is converted to match with the resolution of the other.

### SUMMARY OF THE INVENTION

It is therefore an object of the invention to provide an image processing apparatus capable of producing a printed output without deteriorating a print quality in each of a text and a picture even when an original contains the both.

An image processing apparatus of the invention is an image processing apparatus that performs image processing when a printing resolution of an image output apparatus is higher than a reading resolution of an image input apparatus, so that image data read by the image input apparatus is converted to image data having a high resolution to be outputted from the image output apparatus. When an original contains both a text and a picture, the apparatus performs image-region segmentation processing to identify the text and the picture, and increases a resolution of a text region to be higher than a resolution of a picture region within an output image of the original, while making the number of pixels equal in the entire output image after binarization of each region.

### BRIEF DESCRIPTION OF THE DRAWINGS

FIG. 1 is a schematic view showing a configuration of an image processing apparatus according to one embodiment of the invention;

FIG. 2 is a schematic view showing image data inputted from an image input apparatus to the image processing apparatus according to one embodiment of the invention;

FIG. 3 is a schematic view showing image data after resolution conversion subsequent to image-region segmentation processing by the image processing apparatus according to one embodiment of the invention;

FIG. 4 is a schematic view showing image data being subjected to pixel-number equalization processing subsequent to binarization processing by the image processing apparatus according to one embodiment of the invention;

FIG. 5 is a schematic view showing image data after the pixel-number equalization processing subsequent to binarization processing by the image processing apparatus according to one embodiment of the invention;

FIG. 6 is a schematic view showing image data inputted into a conventional image processing apparatus;

FIG. 7 is a schematic view showing resolution conversion processing in a case of where image data inputted into the conventional image processing apparatus is data of a text region;

FIG. 8 is a schematic view showing resolution conversion processing in a case of where image data inputted into the conventional image processing apparatus is data of a picture region;

FIG. 9 is a schematic view showing a size of isolated dots when image data inputted into the conventional image processing apparatus is data containing both a text region and a picture region and the data of the picture region is subjected to resolution conversion processing to match with a resolution of 300 dpi; and

FIG. 10 is a schematic view showing a size of isolated dots when the image data inputted into the conventional image processing apparatus is data containing both a text region and a picture region and the data of the picture region is subjected to resolution conversion processing to match with a resolution of 600 dpi.

### DETAILED DESCRIPTION OF THE PREFERRED EMBODIMENTS

The following description will describe an embodiment of the invention.

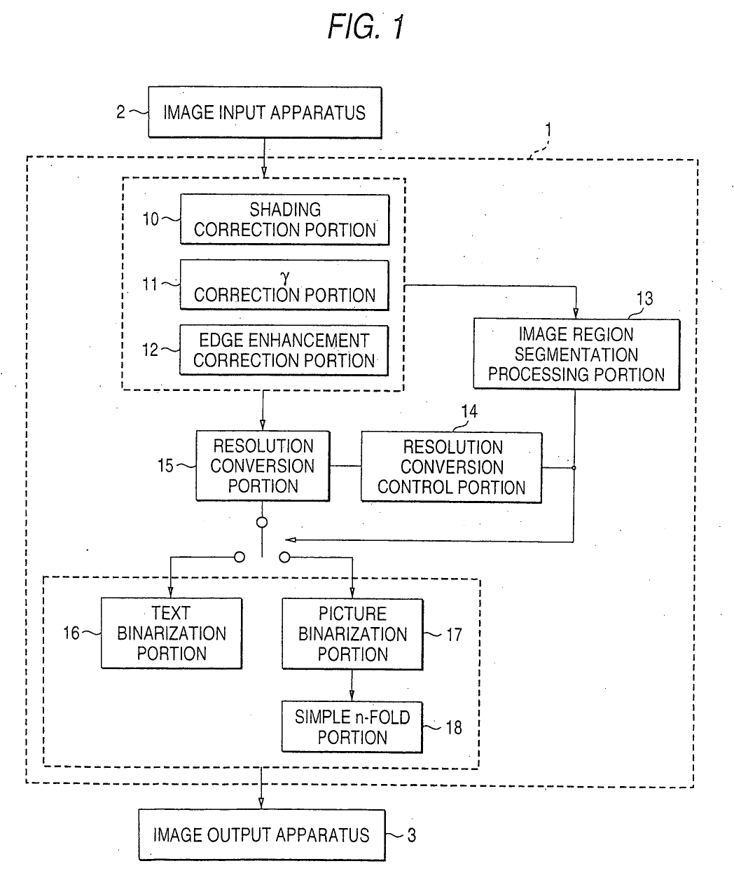

An embodiment of the invention will now be described in detail with reference to FIG. 1 through FIG. 5.

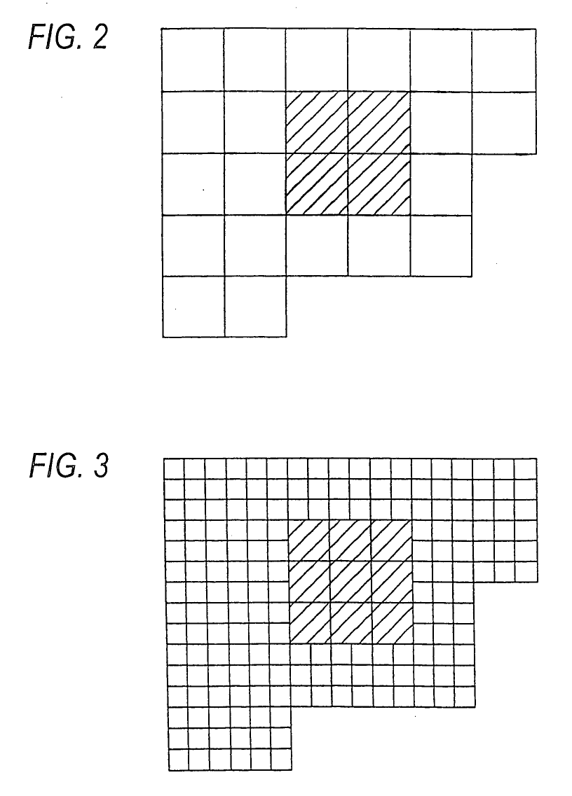

FIG. 1 is a schematic view showing a configuration of an image processing apparatus according to one embodiment of the invention. FIG. 2 is a schematic view showing image data inputted from an image input apparatus to the image processing apparatus according to one embodiment of the invention. FIG. 3 is a schematic view showing image data after resolution conversion subsequent to image-region segmentation processing by the image processing apparatus according to one embodiment of the invention.

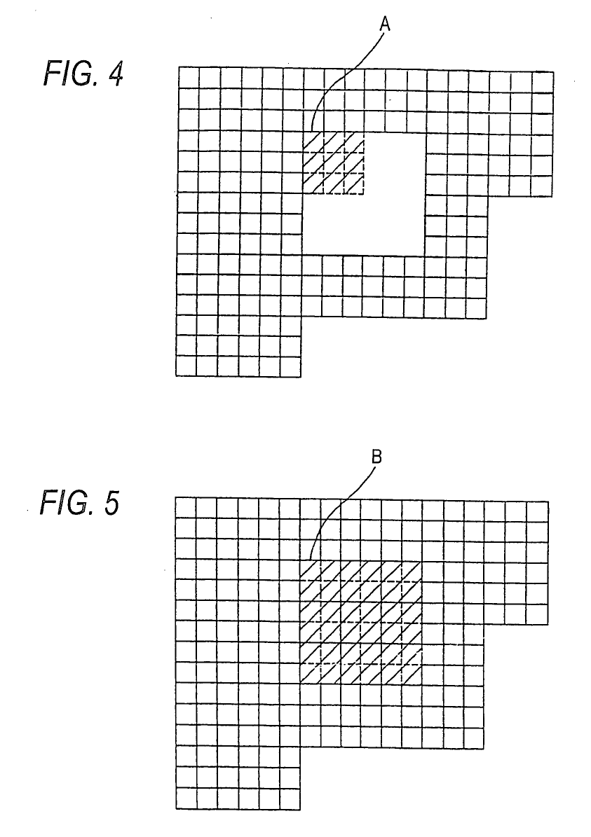

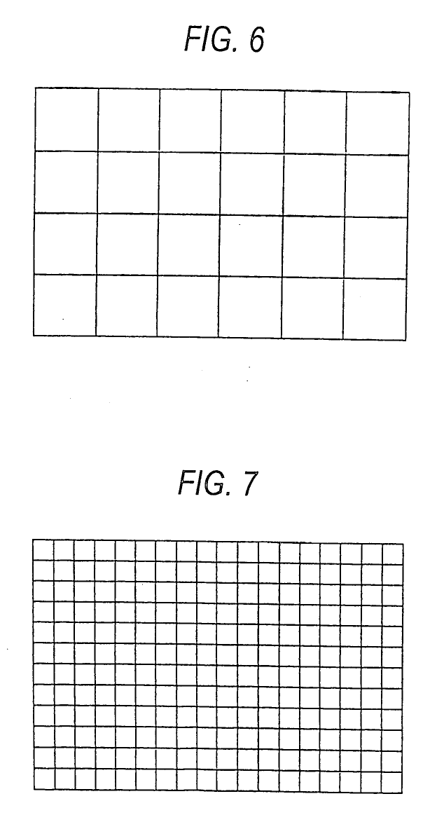

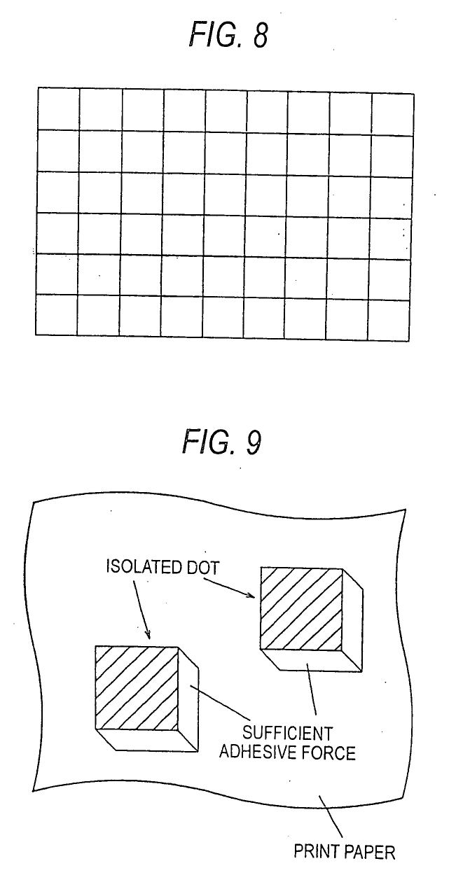

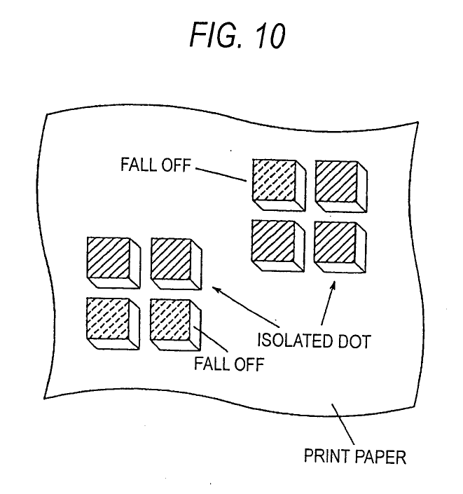

FIG. 4 is a schematic view showing image data being subjected to pixel-number equalization processing subsequent to binarization processing by the image processing apparatus according to one embodiment of the invention. FIG. 5 is a schematic view showing image data after the pixel-number equalization processing subsequent to binarization processing by the image processing apparatus according to one embodiment of the invention.

A facsimile machine, a copying machine and the like are furnished with a copying function, and the copying function is realized, as shown in FIG. 1, by connecting an image input apparatus 2 that reads an image, such as a scanner, and an image output apparatus 3 used for printing, such as a printer, to an image processing apparatus 1.

Incidentally, under the current circumstances, for a facsimile or the like provided with a high-resolution electrophotographic printer, it is general that a resolution of the printer is a few times higher than a resolution of the scanner that reads an original. For example, the scanner used as the image input apparatus 2 shown in FIG. 1 has a low resolution of 200 dpi and the printer used as the image output apparatus 3 has a high resolution of 600 dpi.

Initially, image data having a resolution of 200 dpi read by the image input apparatus 2 in the form of an analog image signal is converted into digital data (multi-valued data) by an A/D converter or the like, and is then sent to the image processing apparatus 1. The image processing apparatus 1 applies various corrections, including the shading correction, the gamma correction, and the edge enhancement correction (MTF correction) to the image data still having a resolution of 200 dpi by means of a shading correction portion 10, a gamma correction portion 11, and an edge enhancement correction portion 12, respectively.

Then, an image-region segmentation processing portion 13 performs image-region segmentation processing to segment the image data into a text region (text image) and a picture region (picture image). By performing this image-region segmentation processing, the image-region segmentation processing portion 13 judges whether image data of interest (image data of an original read by the image input apparatus 2) has a text region (text image data) alone, a picture region (picture image data) alone, or both the text region (text image data) and the picture region (picture image data), and upon judging that the original contains both the text region (text image) and the picture region (picture image), the image-region segmentation processing portion 13 identifies the text region (text image) and the picture region (picture image) to be segmented.

Then, resolution conversion is performed on each of the text region (text image) and the picture region (picture image) in consideration of the resolution of the image output apparatus 3, so that an optimal printing result can be obtained. The resolution conversion is performed by a resolution conversion portion 14 and a resolution conversion control portion 15.

To this end, an optimal resolution converting ratio is set for each of the text region (text image) and the picture region (picture image). Given 600 dpi as the resolution of the image output apparatus 3 shown in FIG. 1, then a 3-fold conversion factor is given as the resolution converting ratio for the text region (text image), so that resolution conversion from 200 dpi to 600 dpi is performed. For the picture region (picture image), a 1.5-fold conversion factor is given as the resolution converting ratio, so that resolution conversion from 200 dpi to 300 dpi is performed.

The reason why a 3-fold conversion factor is given as the resolution converting ratio for the text region to match with 600 dpi, which is the highest resolution of the image output apparatus 3, is as follows. That is, as, has been described in the prior art column, a portion of a text is represented as a set of linked dots, that is, a set of continuous dots. Hence, as the resolution is increased, a contour of text image represented by a set of continuous dots becomes smoother, and a printing result of a higher quality can be obtained. For this reason, the resolution converting ratio is set to match with the highest resolution of the image output apparatus 3. For example, when the highest resolution of the image output apparatus 3 is 1200 dpi, a 6-fold conversion factor is given as the resolution converting ratio to match with the highest resolution of 1200 dpi.

Contrary to this, the reason why a 1.5-fold conversion factor (such that multiplies 200 to 300) is given as the resolution converting ratio for the picture region (picture image data) to match with 300 dpi, which is a medium resolution of the image output apparatus 3, is as follows. That is, as has been also described in the prior art column, because the half-tone dot meshing processing is applied to a portion of the picture region (picture image data), a picture image is represented not by a set of continuous dots like a text, but by a set of discrete dots, that is, a set of isolated dots. For this reason, it is necessary to maintain the isolated dots to be of an adequate size to make it easier for the isolated dots to fix to print paper, that is, to prevent the isolated dots from falling off from print paper. For example, even when 400 dpi is given as the resolution, a 2-fold conversion factor (such that multiplies 200 to 400) may be given as the resolution converting ratio for the picture region to match with 400 dpi provided that the isolated dots can readily fix to print paper.

When an original contains both a text region and a picture region, the invention enables the text region (text image data) and the picture region (picture image data) to be printed at their respective optimal resolutions, and a configuration enabling such printing will now be described.

As shown in FIG. 2, the image data inputted from the image input apparatus 2 has a resolution of 200 dpi, and contains both the text region (text image) and the picture region (picture image) indicated by hatching. As has been described with reference to FIG. 1, the image processing apparatus 1 of this embodiment performs image-region segmentation processing, and performs resolution conversion on each of the text region (text image data) and the picture region (picture image data) thus identified and segmented, using different resolution converting ratios, so that the text region (text image data) is converted to have a resolution of 600 dpi, which is the highest resolution of the image output apparatus 3. Referring to FIG. 3, the pixels in the text region (text image data) having undergone 3-fold resolution conversion from 200 dpi to 600 dpi are now increased 9-fold.

Likewise, the picture region (picture image data) segmented by the image-region segmentation processing is subjected to resolution conversion to match with 300 dpi, which is a medium resolution of the image output apparatus 3. Referring to FIG. 3, the pixels in the picture region (picture image) having undergone 1.5-fold resolution conversion from 200 dpi to 300 dpi are now increased 2.25-fold.

For example, given 1200 dpi as the highest resolution of the image output apparatus 3, 6-fold resolution conversion from 200 dpi to 1200 dpi may be performed for the text region. Also, provided that isolated dots can readily fix to print paper at a resolution of 400 dpi, 2-fold resolution conversion from 200 dpi to 400 dpi may be performed for the picture region.

Herein, for the convenience of the subsequent pixel-number equalization processing, it is important that a resolution converting ratio for the text region (text image) is invariably an integral multiple of a resolution converting ratio for the picture region (picture image), where the integral multiple is two or greater.

When the resolution conversion of the text region (text image data) and the picture region (picture image region) as shown in FIG. 3 is completed, optimal binarization is performed on each of the text region (text image) and the picture region (picture image) by a text region binarization portion 16 and a picture binarization portion 17. Referring to FIG. 1, for example, the text region (text image) is binarized through simple binarization, floating slice, etc., and the picture region (picture image) is binarized through pseudo half-tone processing, such as error diffusion and dither matrix.

Referring to FIG. 3, the number of pixels per unit area in the text region (text image data) having undergone resolution conversion to 600 dpi is twice as large as the number of pixels per unit area in the text region (text image data) having undergone resolution conversion to 300 dpi (because it is pre-set so that the number of pixels in the former will be an integral multiple of that in the latter, where the integral multiple is two or greater). When the number of pixels per unit area differs (when the size of pixels differs) within an output image of the original, the numbers of pixels in the picture region (picture image) indicated by hatching and in the text region (text image) are made equal for ease of image processing.

By converting the picture image having a resolution of 300 dpi as shown in FIG. 3 to have a pixel size comparable to that for a resolution of 600 dpi, the picture region can be reduced by 50% (see FIG. 4).

As has been described in the description of the background, the isolated dots at a resolution of 600 dpi are small, and an adhesion force of the individual isolated dots is deteriorated to the extent that they fall off from print paper. In order to allow the isolated dots to maintain an adhesion force at a resolution of 600 dpi, enlargement conversion is performed by mapping one pixel at a resolution of 300 dpi onto four pixels at a resolution of 600 dpi one by one. In other words, picture image data A comprising reduced nine pixel regions as shown in FIG. 4 is copied with the picture image data in each pixel region being enlarged by four times without changing the mutual positional relation of the pixel regions, that is, copy pixel data of the pixel data in each pixel region is generated. The copy pixel data thus generated is appended to the region of the picture image data before the equalization processing was applied to the picture image data, and picture image data of pixel regions indicated by a capital B is thus obtained. Consequently, as shown in FIG. 5, the picture region (picture image) is enlarged by two times and is restored at an enlargement ratio of 100%. This is referred to as “simple 2-fold enlargement”, which is one of the enlargement methods. This operation is performed by a simple n-fold portion 18.

As has been described, by setting a resolution converting ratio of a picture region to 1/n (n is an integer greater than 1) of a resolution converting ratio of a text region, and by performing simple n-fold enlargement after binarization, it is possible to perform pixel-number equalization processing by which the number of pixels per unit area is made equal. For example, given 400 dpi as the resolution of the picture region and 1200 dpi as the resolution of the text region, then the pixel-number equalizing processing can be performed by simply enlarging the picture region by three times.

After the pixel-number equalizing processing, the whole image data is formed with the text region having a resolution adequate for the text region, the picture region having a resolution adequate for the picture region, and the number of pixels in both the text region and the picture region being equal to the number of pixels at the resolution of the text region. When the image data done with the pixel-number equalizing processing as described above is outputted from the image output apparatus 3, too small isolated dots are eliminated from both the text region and the picture region, and only the isolated dots of an adequate size having an adequate adhesion force to print paper are present. Hence, an overall printing result of a high quality can be obtained.

As has been described, in this invention, when an original contains both a text and a picture, a resolution converting ratio of a picture region is set to 1/n of a resolution converting ratio of a text region, and the pixel-number equalizing processing is performed by applying simple n-fold enlargement to the picture region after binarization. Hence, a satisfactory printing result can be obtained both in the text region and the picture region.

The outline of one embodiment of the invention is that the image processing apparatus is devised to improve a print quality by performing the image-region segmentation processing for an original containing both a text and a picture to identify a text region and a picture region, and applying optimal resolution conversion to each of the text region and the picture region, so that the resolution of the text region will be an integral multiple of the resolution of the picture region, as well as performing the pixel-number equalizing processing after each resolution-converted region is binarized in making the number of pixels in the picture region converted to have a lower region than the text region equal to the number of pixels in the text region by simply increasing the pixels in the text region by a factor of an integer, so that the pixel number will be equal in the entire output image.

Many modifications and variations of the present invention are possible in the light of the above techniques. It is therefore to be understood that within the scope of the invention the invention may be practiced otherwise than as specifically described.

### CROSS REFERENCE TO RELATED APPLICATION

This application is based upon and claims the benefit of priority of Japanese Patent Application No. 2002-345483 filed on Nov. 28, 2002, the contents of which are incorporated herein by reference in its entirety.

What is claimed is:

1. An image processing apparatus that reads an image at a first resolution and produces a printed output at a second resolution higher than the first resolution, the apparatus comprising:
read means for reading image data of an original at the first resolution;
A/D converting means for subjecting the read image data to A/D conversion;
segmentation means for segmenting the A/D-converted image data into text image data and picture image data;
resolution converting means for converting the text image data to have a third resolution higher than the first resolution, and the picture image data to have a fourth resolution lower than the third resolution, the third resolution being an integral multiple of the fourth resolution, where the integral multiple is two or greater;
binarization means for binarizing the resolution-converted text image data and the resolution-converted picture image data;
reducing means for processing the binarized picture image data to match a size of pixels thereof with a size of pixels at the second resolution with the number of the pixels maintained;
developing means for generating copy pixels of the pixels of the picture image data processed in the reducing means one by one with a mutual positional relation of the pixels maintained, and appending the copy pixels to a region of the picture image data before equalization processing was performed on the picture image data; and
printing means for printing the picture image data done with development processing and the text image data at the second resolution.

2. The image processing apparatus according to claim 1, wherein the second resolution is equal to the third resolution.

3. The image processing apparatus according to claim 1, wherein the binarization means binarizes the picture image data through one of error diffusion and a dither matrix method, and binarizes the text image data through a floating slice method.

4. An image processing apparatus that receives image data at a first resolution and produces printed data at a second resolution higher than the first resolution, the apparatus comprising:
A/D converting means for subjecting image data to A/D conversion;
segmentation means for segmenting the A/D-converted image data into text image data and picture image data;
resolution converting means for converting the text image data to have a third resolution higher than the first resolution, and the picture image data to have a fourth resolution lower than the third resolution, the third resolution being an integral multiple of the fourth resolution, where the integral multiple is two or greater;
binarization means for binarizing the resolution-converted text image data and the resolution-converted picture image data;
reducing means for processing the binarized picture image data to match a size of pixels thereof with a size of pixels at the second resolution with the number of the pixels maintained; and
developing means for generating copy pixels of the pixels of the picture image data processed in the reducing means one by one with a mutual positional relation of the pixels maintained, and appending the copy pixels to a region of the picture image data before equalization processing was performed on the picture image data.
